(19) United States
(12) Patent Application Publication
(10) Pub. No.: US 2025/0233656 A1
(43) Pub. Date: Jul. 17, 2025

(54) ELECTRONIC APPARATUS AND NETWORK SYSTEM

(71) Applicant: NEC Corporation, Tokyo (JP)

(72) Inventor: Masashi HAYASHI, Tokyo (JP)

(73) Assignee: NEC Corporation, Tokyo (JP)

(21) Appl. No.: 18/978,402

(22) Filed: Dec. 12, 2024

(30) Foreign Application Priority Data
Jan. 11, 2024 (JP) 2024-002675

(51) Int. Cl. H04B 10/079; H04B 1/40

(52) U.S. Cl. CPC H04B 10/0795; H04B 1/40

(57) ABSTRACT

An electronic apparatus according to the present disclosure includes a plurality of electronic components, a transmission path in which a plurality of the electronic components are provided in series, and a local controller that monitors a plurality of the electronic components. The local controller includes a first monitoring port connected to the transmission path and a second monitoring port connected to the first monitoring port via the transmission path. Each of a plurality of the electronic components includes a first communication port connectable to the first monitoring port, a second communication port connectable to the second monitoring port, and a transceiver communicating with the local controller via the first communication port or the second communication port.

### INCORPORATION BY REFERENCE

This application is based upon and claims the benefit of priority from Japanese patent application No. 2024-002675, filed on Jan. 11, 2024, the disclosure of which is incorporated herein in its entirety by reference.

### TECHNICAL FIELD

The present disclosure relates to an electronic apparatus and a network system.

### BACKGROUND ART

In general, an electronic apparatus including a plurality of electronic components is provided with a local controller that monitors each electronic component. For example, an optical transmission apparatus as an electronic apparatus is equipped with local controllers that monitor electronic components such as a transponder (TPND), a multiplexer/demultiplexer (Add/Drop), a wavelength selective switch (WSS), and an optical amplifier (AMP). The local controller is connected to each electronic component to be monitored, thereby achieving monitoring of each electronic component.

In recent years, only necessary electronic components among a plurality of electronic components are selected and mounted on an electronic apparatus in some cases. In such a case, each electronic component is manufactured in such a way as to be separable from the electronic apparatus, unlike a case where the electronic component is integrally mounted on the electronic apparatus. Therefore, the number of electronic components mounted on the electronic apparatus is not determined.

However, in a case where a sufficient number of ports for connecting to the electronic components are provided in the local controller, the local controller can monitor the electronic components even if many electronic components are mounted in the electronic apparatus. However, since the electronic apparatus has a limited resource, it is difficult to increase the number of ports of the local controller without limit.

Therefore, in recent years, a technique for monitoring an electronic component mounted on an electronic apparatus while reducing the number of ports of a local controller has also been proposed.

For example, Japanese Unexamined Patent Application Publication No. 2023-047469 discloses a technique in which a plurality of nodes to be monitored are connected in a line shape, and a system controller apparatus monitors the plurality of nodes connected in a line shape. According to this configuration, since the system controller apparatus does not need to individually provide ports for one-to-one communication with each of the plurality of nodes, the number of ports can be reduced.

### SUMMARY

However, in the technique disclosed in Japanese Unexamined Patent Application Publication No. 2023-047469, elements for monitoring each node are not redundant in the system controller apparatus. Therefore, in the system controller apparatus, in a case where an element for monitoring each node fails, monitoring control cannot be continued. Therefore, it is also an important issue to ensure redundancy in monitoring control.

Therefore, in view of the problem described above, an example object of the present disclosure is to provide an electronic apparatus and a network system that are capable of securing redundancy in monitoring control of each electronic component while reducing the number of ports of a local controller.

In a first example aspect, an electronic apparatus includes a plurality of electronic components, a transmission path in which the plurality of electronic components are provided in series, and a local controller configured to monitor the plurality of electronic components. The local controller includes a first monitoring port connected to the transmission path and a second monitoring port connected to the first monitoring port via the transmission path. Each of the plurality of electronic components includes a first communication port connectable to the first monitoring port, a second communication port connectable to the second monitoring port, and a transceiver communicating with the local controller via the first communication port or the second communication port.

In a second example aspect, a network system includes an electronic apparatus and a network management system (NMS) for monitoring the electronic apparatus.

An example advantage according to the above-described aspects is that it is possible to provide an electronic apparatus and a network system that are capable of monitoring each electronic component without increasing the number of ports of a local controller.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a diagram illustrating a configuration example of a network system according to the present disclosure;

FIG. 2 is a diagram illustrating an operation example of a network system according to the present disclosure in a case where an SLC collects neighboring BOX information from each of a plurality of BOXs;

FIG. 3 is a diagram illustrating an example of network topology information of a transmission path in the state of FIG. 2;

FIG. 4 is a diagram illustrating an operation example of a network system according to the present disclosure in a case where a BOX is newly installed;

FIG. 5 is a diagram illustrating a configuration example of a network system according to the present disclosure;

FIG. 6 is a diagram illustrating an operation example of a network system according to the present disclosure in a case where the SLC collects neighboring BOX information from each of the plurality of BOXs;

FIG. 7 is a diagram illustrating an example of the network topology information of the transmission path in the state of FIG. 6;

FIG. 8 is a diagram illustrating an operation example of a network system according to the present disclosure in a case where the BOX is removed;

FIG. 9 is a diagram illustrating an example of the network topology information of the transmission path in the state of FIG. 8;

FIG. 10 is a diagram illustrating an operation example of a network system according to the present disclosure in a case where a BOX is installed as an alternative;

FIG. 11 is a diagram illustrating an example of the network topology information of the transmission path in the state of FIG. 10;

FIG. 12 is a diagram illustrating an operation example of a network system according to the present disclosure in a case where a BOX is installed by misconnection;

FIG. 13 is a diagram illustrating an example of the network topology information of the transmission path in the state of FIG. 12;

FIG. 14 is a diagram illustrating a configuration example of the network system according to the present disclosure;

FIG. 15 is a diagram illustrating a configuration example of the network system according to the present disclosure; and

FIG. 16 is a block diagram illustrating a configuration example of hardware of a computer that achieves the electronic apparatus according to the present disclosure.

### EXAMPLE EMBODIMENT

Hereinafter, example embodiments of the present disclosure are described with reference to the drawings. Note that the following description and the drawings are omitted and simplified as appropriate for clarity of description. In the following drawings, the same elements are denoted by the same reference numerals, and redundant descriptions are omitted as necessary.

### Example Embodiment 1

First, a configuration example of a network system 1 is described.

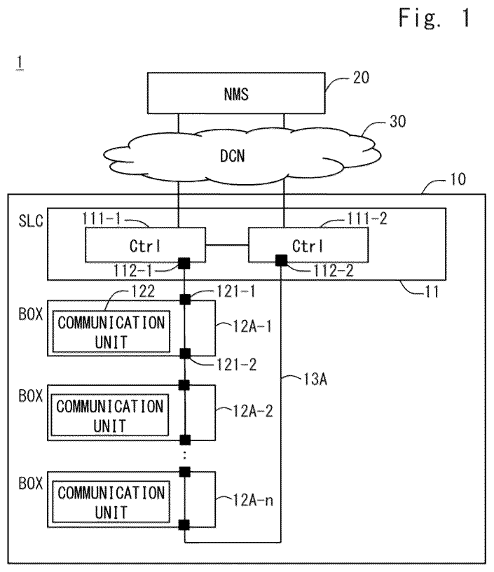

FIG. 1 is a diagram illustrating a configuration example of the network system 1.

As illustrated in FIG. 1, the network system 1 includes an electronic apparatus 10 and a network management system (NMS) 20.

The NMS 20 monitors the electronic apparatus 10 via a data communication network (DCN) 30.

The electronic apparatus 10 includes a site local controller (SLC) 11, a plurality of BOXs 12A-1 to 12A-n (n is a natural number equal to or greater than 2), and a transmission path 13A.

In FIG. 1 and the drawings described below, the BOXs 12A-1 to 12A-n are appropriately denoted as BOXs A-1 to A-n. In the following description, if it is not specified which BOXs 12A-1 to 12A-n are, they are referred to as BOXs 12 as appropriate.

The electronic component is mounted on the electronic apparatus 10 as the BOX 12. However, the method of mounting the electronic component on the electronic apparatus 10 is not limited thereto. The electronic component may be mounted on the electronic apparatus 10 in such a manner that the BOX 12 is not interposed.

The electronic apparatus 10 is, for example, an optical transmission apparatus. In a case where the electronic apparatus 10 is an optical transmission apparatus, the electronic components are, for example, a transmitter (TPND), a multiplexer/demultiplexer, a wavelength selective switch (WSS), an optical amplifier (AMP), and the like.

The SLC 11 monitors each of the plurality of BOXs 12A-1 to 12A-n. The SLC 11 is an example of a local controller.

The SLC 11 has a redundant configuration including two controller units 111-1, 111-2 capable of monitoring each of the plurality of BOXs 12A-1 to 12A-n. Thus, even if one of the controller units 111-1, 111-2 fails, the SLC 11 can continue monitoring the BOX 12 by the other. Therefore, in the SLC 11, one of the controller units 111-1, 111-2 is in the active state, the BOX 12 is monitored, and the other is in the standby state.

The SLC 11 includes two monitoring ports 112-1, 112-2. Specifically, the controller unit 111-1 includes the monitoring port 112-1, and the controller unit 111-2 includes the monitoring port 112-2. In the following description, the monitoring port 112-1, 112-2 is referred to as the monitoring port 112 as appropriate if it is not specified.

The monitoring port 112-1 is connected to the transmission path 13A. The monitoring port 112-2 is connected to the monitoring port 112-1 via the transmission path 13A.

The transmission path 13A is a loop-shaped (ring-shaped) transmission path, and the plurality of BOXs 12A-1 to 12A-n is provided in series on the transmission path 13A.

Each of the plurality of BOXs 12A-1 to 12A-n includes communication ports 121-1, 121-2 and a communication unit 122.

The communication port 121-1 can be connected to the monitoring port 112-1 via the transmission path 13A. The communication port 121-2 is connectable to the monitoring port 112-2 via the transmission path 13A.

The communication unit 122 communicates with the SLC 11 via the communication port 121-1 or 121-2.

In the communication unit 122, which of the communication ports 121-1, 121-2 is to be used is determined according to the position of a blocking port to be described later provided on the transmission path 13A. The communication unit 122 determines the position of the blocking port according to a spanning tree protocol (STP), which is a loop-countermeasure protocol, and determines which of the communication ports 121-1, 121-2 is to be used according to the determined position of the blocking port.

Next, an operation example of the network system 1 is described.

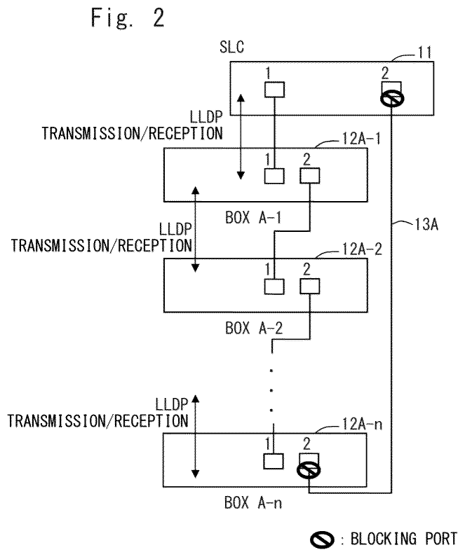

FIG. 2 is a diagram illustrating an operation example in a case where the SLC 11 collects neighboring BOX information from each of the plurality of BOXs 12A-1 to 12A-n in the network system 1.

In FIG. 2 and the drawings described later, in the SLC 11, the monitoring ports 112-1 and 112-2 are appropriately illustrated as the monitoring ports 1 and 2. Further, in each BOX 12, the communication ports 121-1 and 121-2 are indicated as the communication ports 1 and 2 as appropriate.

In the example of FIG. 2, the communication port 121-2 of the BOX 12A-n and the monitoring port 112-2 of the SLC 11 serve as a blocking port. Therefore, the communication unit 122 communicates with the controller unit 111-1 using the communication port 121-2.

As illustrated in FIG. 2, each of the plurality of BOXs 12A-1 to 12A-n acquires neighboring BOX information that is information of the neighboring BOX 12 by using a link layer discovery protocol (LLDP). The neighboring BOX information is information representing the neighboring BOX 12 and the communication ports 121-1, 121-2 of the neighboring BOX 12 connected to the BOX 12.

The SLC 11 collects neighboring BOX information from each of the plurality of BOXs 12A-1 to 12A-n using LLDP.

Further, the SLC 11 generates network topology information of the transmission path 13A, based on the neighboring BOX information collected from each of the plurality of BOXs 12A-1 to 12A-n, and stores the generated network topology information.

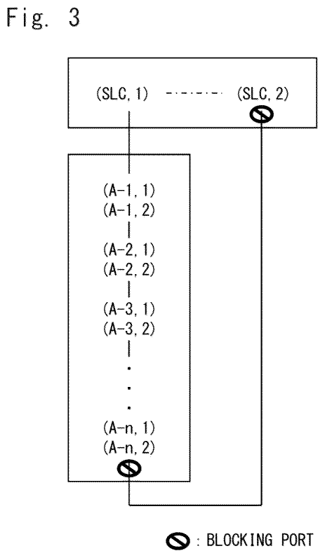

FIG. 3 is a diagram illustrating an example of network topology information of the transmission path 13A in the state of FIG. 2.

In FIG. 3 and the drawings described below, the notation in parentheses in the network topology information represents (apparatuses, ports). In addition, a solid line connecting the parentheses in the network topology information represents a cable connection, and a dashed-dotted line represents a connection inside the SLC 11.

For example, in FIG. 3, (SLC,1) represents the monitoring port 112-1 of the SLC 11, (SLC,2) represents the monitoring port 112-2 of the SLC 11, and (A-1,1) represents the communication port 121-1 of the BOX 12A-1. In addition, since the monitoring port 112-1 of the SLC 11 and the communication port 121-1 of the BOX 12A-1 are connected by a cable, the (SLC, 1) and (A-1, 1) are connected by a solid line. Further, since the monitoring port 112-1 of the SLC 11 and the monitoring port 112-2 of the SLC 11 are connected within the SLC 11, the (SLC, 1) and (SLC, 2) are connected by a dashed-dotted line.

As described above, the network topology information of the transmission path 13A indicates the positions of the respective BOXs 12 on the transmission path 13A and also indicates the communication ports 121-1, 121-2 connected to the transmission path 13A at the positions.

Note that the collection operation illustrated in FIG. 2 is performed periodically. Therefore, the network topology information of the transmission path 13A is periodically updated.

The SLC 11 also stores type information and configuration information of each of the plurality of BOXs 12A-1 to 12A-n. The type information and the configuration information of each BOX 12 are manually set in the SLC 11 by the user using the NMS 20.

The type information of each BOX 12 is information indicating the type of the BOX to be installed at the position of each BOX 12.

The configuration information of each BOX 12 is information related to the setting of the BOX to be installed at the position of each BOX 12.

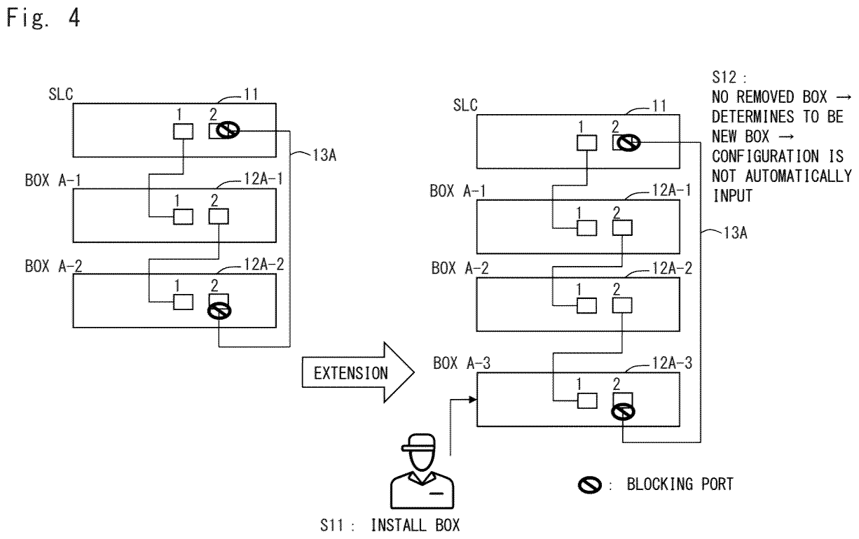

FIG. 4 is a diagram illustrating an operation example in a case where the BOX 12 is newly installed in the network system 1. FIG. 4 is a diagram illustrating an example in which the BOX 12A-3 is newly installed while BOXs 12A-1, 12A-2 are already installed in the electronic apparatus 10.

As illustrated in FIG. 4, the user installs the BOX 12A-3 by incorporating the BOX 12A-3 into the transmission path 13A. Specifically, the user connects the communication ports 121-1, 121-2 of the BOX 12A-3 to the transmission path 13A (S11).

Here, the SLC 11 updates the network topology information of the transmission path 13A by the collection operation of FIG. 2 performed at regular timing after the installation of the BOX 12A-3. Therefore, the SLC 11 knows that the BOX 12A-3 is installed, the position where the BOX 12A-3 is installed, the communication port 121-1, 121-2 connected to the transmission path 13A at the position, and the like, based on the updated network topology information. Further, the SLC 11, based on the network topology information before the update, before the installation of the BOX 12A-3, can see that the removal of the BOX 12 is not performed at the position where the BOX 12A-3 is installed. Therefore, the SLC 11 determines that the BOX 12A-3 is newly installed and is not an alternative. In this case, unlike the case where the BOX 12A-3 is installed as an alternative, the SLC 11 does not transmit the configuration information to the BOX 12A-3 as described later (S12).

Although not illustrated in the drawings, the type information and the configuration information regarding the BOX to be installed at the position of the BOX 12A-3 are manually set in the SLC 11 by the user using the NMS 20 at any timing thereafter.

As described above, according to the first example embodiment, the SLC 11 includes the monitoring port 112-1 connected to the transmission path 13A and the monitoring port 112-2 connected to the monitoring port 112-1 via the transmission path 13A. Each of the plurality of BOXs 12A-1 to 12A-n provided in series on the transmission path 13A includes a communication port 121-1 connectable to the monitoring port 112-1, a communication port 121-2 connectable to the monitoring port 112-2, and a communication unit 122 that communicates with the SLC 11 via the communication port 121-1 or 121-2.

Therefore, since the SLC 11 does not need to individually include the monitoring port 112 for performing one-to-one communication with each of the plurality of BOXs 12A-1 to 12A-n in order to monitor each of the plurality of BOXs 12A-1 to 12A-n, the number of the monitoring ports 112 can be reduced.

Further, the two monitoring ports 112-1, 112-2 included in the SLC 11 are connected to the transmission path 13A. Therefore, the SLC 11 can have a redundant configuration including a controller unit 111-1 that monitors each BOX 12 via the monitoring port 112-1 and a controller unit 111-2 that monitors each BOX 12 via the monitoring port 112-2. Therefore, even if one of the controller units 111-1, 111-2 fails, the monitoring control of each BOX 12 can be continued.

Thus, according to the first example embodiment, it is possible to secure redundancy in monitoring control of each BOX 12 while reducing the number of monitoring ports 112 of the SLC 11.

Further, according to the first example embodiment, since the BOX 12 can be newly installed during operation, scale-up during operation can be flexibly performed.

### Example Embodiment 2

First, a configuration example of a network system 2 is described.

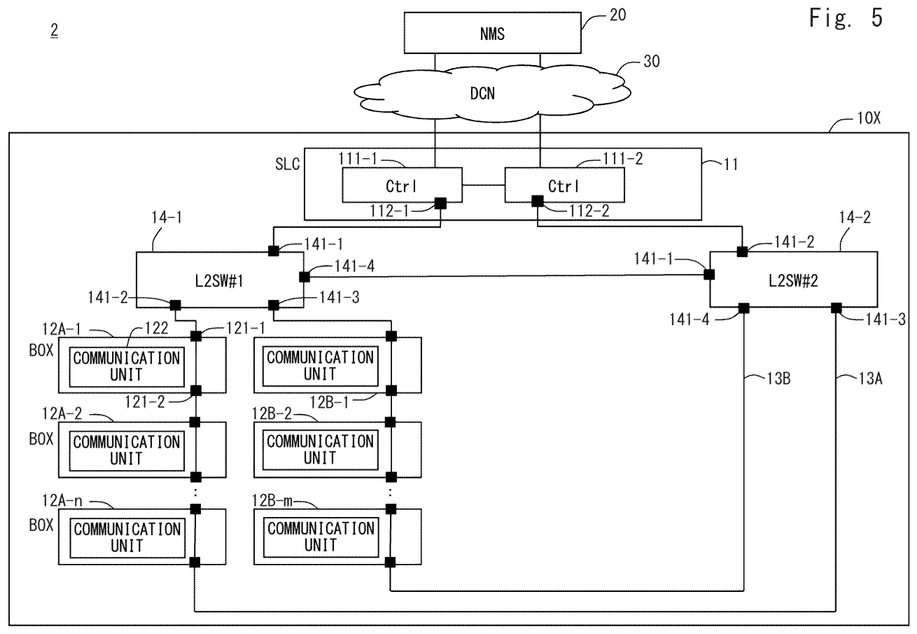

FIG. 5 is a diagram illustrating a configuration example of the network system 2.

As illustrated in FIG. 5, the network system 2 includes an electronic apparatus 10X instead of the electronic apparatus 10, as compared to the network system 1.

The electronic apparatus 10X additionally includes layer 2 switches (L2SW) 14-1 and 14-2 as compared to the electronic apparatus 10.

Further, the electronic apparatus 10X additionally includes a transmission path 13B in which a plurality of BOXs 12B-1 to 12B-m (m is a natural number equal to or greater than 2) are provided in series as compared with the electronic apparatus 10. Note that BOXs 12B-1 to 12B-m have the same structure as the BOXs 12A-1 to 12A-n. In the following description, the BOXs 12A-1 to 12A-n and the BOXs 12B-1 to 12B-m are referred to as a BOX 12 in a case where the BOXs 12A-1 to 12B-m are not specified.

As described above, the electronic apparatus 10X includes two transmission paths 13A and 13B in which the plurality of BOXs 12 are provided in series. In the following description, the transmission path 13A and the transmission path 13B are referred to as the transmission path 13 in a case where the transmission path 13A and the transmission path 13B are not specified. However, the electronic apparatus 10X is not limited to being provided with two transmission paths 13A and 13B, and may be provided with three or more transmission paths 13.

In FIG. 5 and the drawings described below, the BOXs 12B-1 to 12B-m are indicated as BOX B-1 to B-m as appropriate. The L2SW 14-1 and 14-2 are indicated as L2SW #1 and L2SW #2 as appropriate.

The L2SW 14-1 relays the connection between the monitoring port 112-1 and the two transmission paths 13A and 13B. The L2SW 14-1 includes relay ports 141-1 to 141-4. In the L2SW 14-1, the relay port 141-1 is connected to the monitoring port 112-1. Further, the relay port 141-2 is connected to the communication port 121-1 of each BOX 12 on the transmission path 13A. Further, the relay port 141-3 is connected to the communication port 121-1 of each BOX 12 on the transmission path 13B. The relay port 141-4 is connected to a relay port 141-1, which is described later, of the L2SW 14-2.

The L2SW 14-2 relays the connection between the monitoring port 112-2 and the two transmission paths 13A and 13B. The L2SW 14-2 includes relay ports 141-1 to 141-4. In the L2SW 14-2, the relay port 141-2 is connected to the monitoring port 112-2. Further, the relay port 141-3 is connected to the communication port 121-2 of each BOX 12 on the transmission path 13A. Further, the relay port 141-4 is connected to the communication port 121-2 of each BOX 12 on the transmission path 13B. The relay port 141-1 is connected to the relay port 141-4 of the L2SW 14-1.

Next, an operation example of the network system 2 is described.

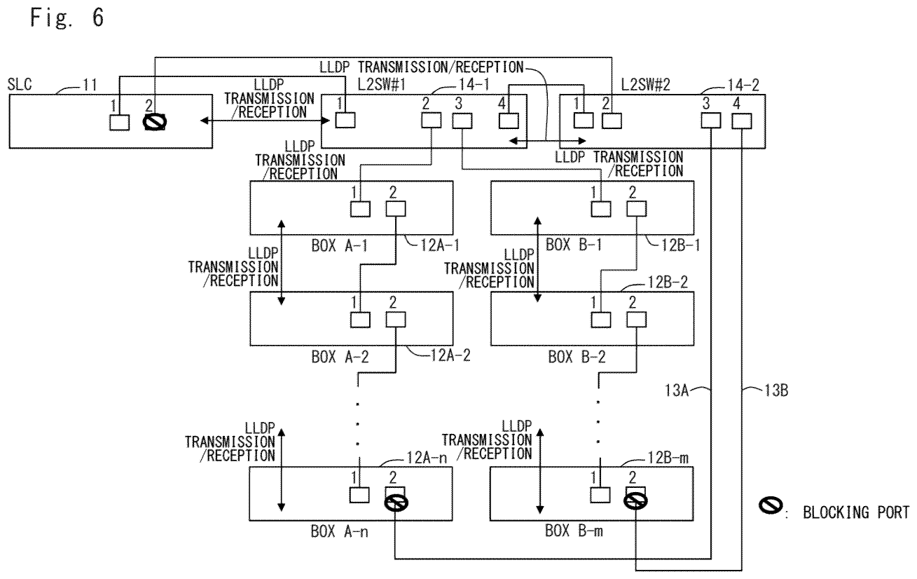

FIG. 6 is a diagram illustrating an operation example in a case where the SLC 11 collects neighboring BOX information from each of the plurality of BOXs 12A-1 to 12A-n and 12B-1 to 12B-m in the network system 2.

In FIG. 6 and the drawings described below, in L2SW 14-1, 14-2, the relay ports 141-1 to 141-4 are indicated as the relay ports 1 to 4 as appropriate.

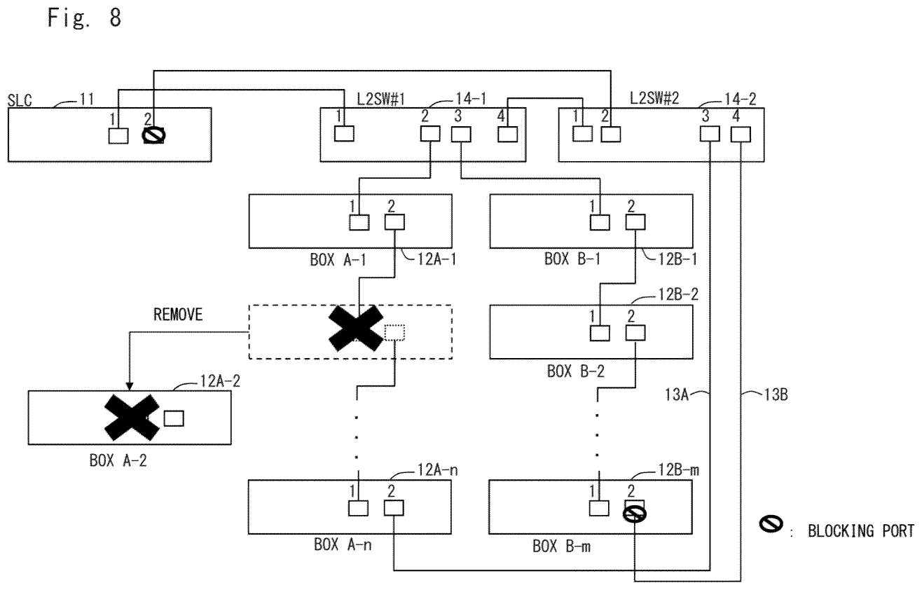

In the example of FIG. 6, the communication port 121-2 of the BOX 12A-n, the communication port 121-2 of the BOX 12B-m, and the monitoring port 112-2 of the SLC 11 serve as blocking ports. For this reason, the communication unit 122 communicates with the controller unit 111-1 using the communication port 121-1 (the same applies to FIGS. 8, 10, and 12).

As illustrated in FIG. 6, each of the plurality of BOXs 12A-1 to 12A-n and 12B-1 to 12B-m acquires neighboring BOX information of the neighboring BOX 12 using LLDP. The neighboring BOX information is the same as that of the first example embodiment described above.

The SLC 11 collects neighboring BOX information from each of the plurality of BOXs 12A-1 to 12A-n and 12B-1 to 12B-m using LLDP.

Further, the SLC 11 generates network topology information of the transmission paths 13A and 13B, based on the neighboring BOX information collected from each of the plurality of BOXs 12A-1 to 12A-n and 12B-1 to 12B-m, and stores the generated network topology information.

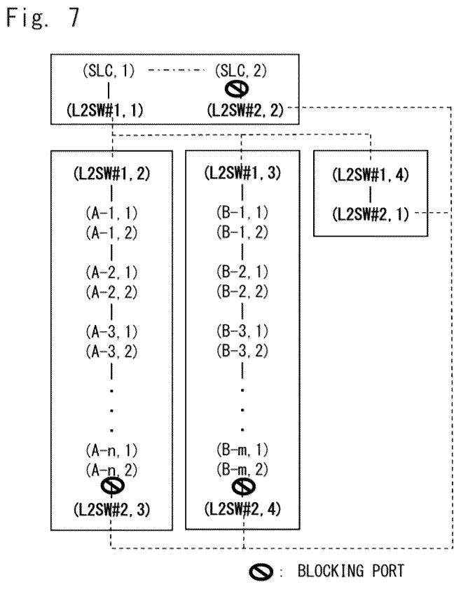

FIG. 7 is a diagram illustrating an example of network topology information of the transmission paths 13A and 13B in the state of FIG. 6.

In FIG. 7 and the drawings described below, the dotted lines connecting the parentheses in the network topology information represent connections within L2SW14-1, 14-2.

For example, in FIG. 7, (L2SW #1,1) represents the relay port 141-1 of the L2SW 14-1, and (L2SW #1,2) represents the relay port 141-2 of the L2SW 14-1. In addition, since the relay port 141-1 of the L2SW 14-1 and the relay port 141-2 of the L2SW 14-1 are connected within the L2SW 14-1, the (L2SW #1, 1) and (L2SW #1, 2) are connected by a dotted line.

As described above, the network topology information of the transmission paths 13A and 13B indicates the positions of the BOXs 12 on the transmission paths 13A and 13B, and also indicates the communication ports 121-1, 121-2 connected to the transmission paths 13A and 13B at the positions.

Note that the collection operation illustrated in FIG. 6 is performed periodically. Therefore, the network topology information of the transmission paths 13A and 13B is periodically updated.

The SLC 11 also stores type information and configuration information of each of the plurality of BOXs 12A-1 to 12A-n and 12B-1 to 12B-m. The type information and the configuration information of each BOX 12 are manually set in the SLC 11 by the user using the NMS 20. The type information and the configuration information are the same as those in the first example embodiment described above.

FIG. 8 is a diagram illustrating an operation example in a case where the BOX 12 is removed in the network system 2. FIG. 8 is an example of removing the BOX 12A-2 on the transmission path 13A.

As illustrated in FIG. 8, the user removes the BOX 12A-2 from the transmission path 13A. Specifically, the user disconnects the communication ports 121-1, 121-2 of the BOX 12A-2 from the transmission path 13A.

Here, the SLC 11 updates the network topology information of the transmission paths 13A and 13B by the collection operation of FIG. 6 performed at regular timing after removal of the BOX 12A-2.

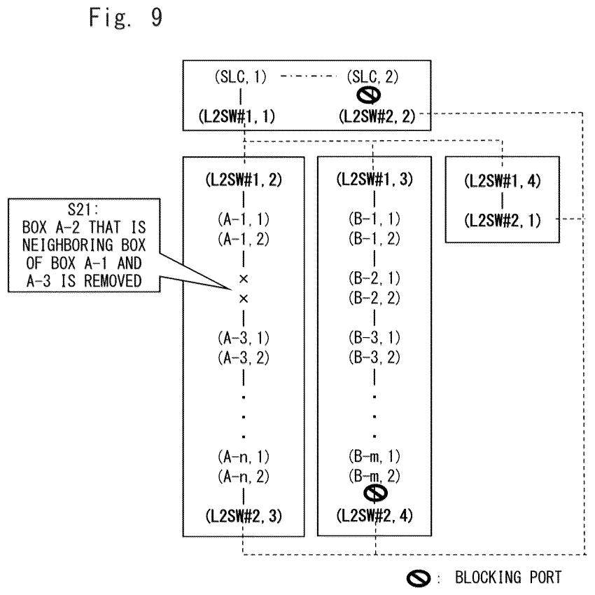

FIG. 9 is a diagram illustrating an example of network topology information of the transmission paths 13A and 13B in the state of FIG. 8.

As illustrated in FIG. 9, the SLC 11 cannot collect the data of the BOX 12A-2 neighboring BOXs 12A-1, 12A-3 from the BOXs 12A-1, 12A-3. Therefore, the information of the BOX 12A-2 is deleted from the network topology information of the transmission path 13A. Accordingly, the SLC 11 determines that the BOX 12A-2 has been removed (S21).

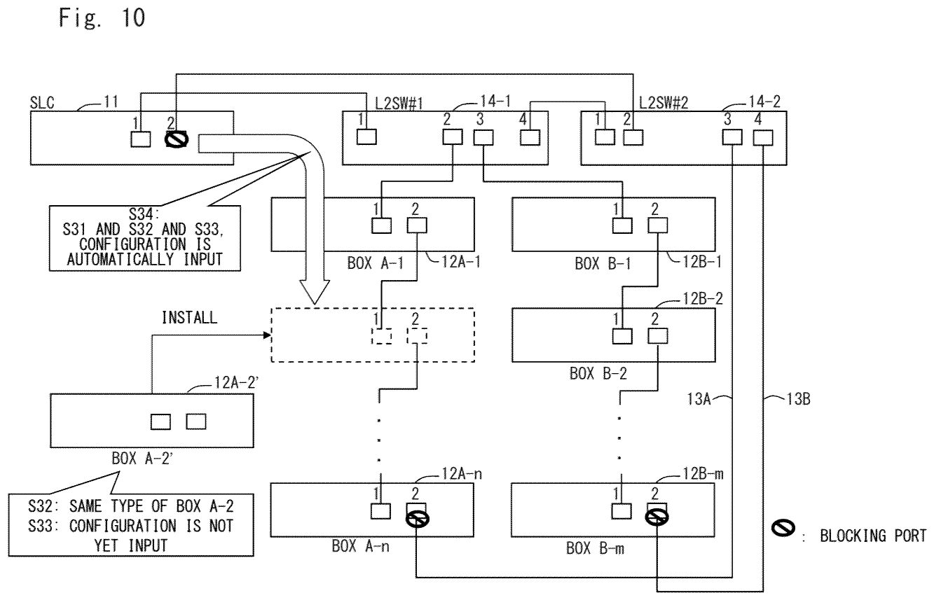

FIG. 10 is a diagram illustrating an operation example in a case where the BOX 12 is installed in the network system 2 as an alternative. FIG. 10 illustrates an example in which the BOX 12A-2′ is installed as an alternative to the BOX 12A-2 at the same position as the BOX 12A-2 on the transmission path 13A.

As illustrated in FIG. 10, the user installs the BOX 12A-2′ at a position where the BOX 12A-2 was installed on the transmission path 13A. Specifically, the user connects the communication ports 121-1, 121-2 of the BOX 12A-2′ to the transmission path 13A at the position where the BOX 12A-2 was installed.

Here, the SLC 11 updates the network topology information of the transmission paths 13A and 13B by the collection operation of FIG. 6 performed at regular timing after the installation of the BOX 12A-2′.

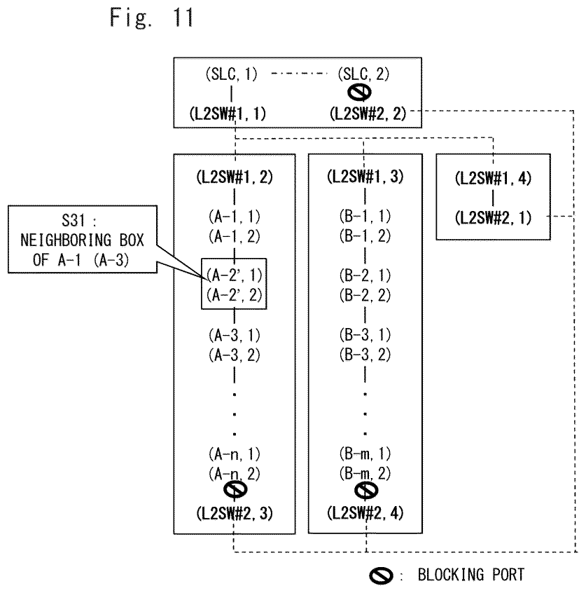

FIG. 11 is a diagram illustrating an example of network topology information of the transmission paths 13A and 13B in the state of FIG. 10.

As illustrated in FIG. 11, the SLC 11 can collect information of the BOX 12A-2′ neighboring the BOXs 12A-1, 12A-3 from the BOXs 12A-1, 12A-3. Therefore, the information of the BOX 12A-2′ neighboring the BOXs 12A-1, 12A-3 is added to the network topology information of the transmission path 13A. Accordingly, the SLC 11 determines that the BOX 12A-2′ is installed at a position neighboring the BOXs 12A-1, 12A-3, that is, at the same position as the BOX 12A-2 (S31).

Further, the SLC 11 stores type information and configuration information related to the BOX 12 to be installed at the position of the BOX 12A-2′. The type information and the configuration information correspond to the type information and the configuration information of the BOX 12A-2.

Therefore, the SLC 11 accesses the BOX 12A-2′ and determines whether the type information set in the BOX 12A-2′ matches the type information stored in the SLC 11. Further, the SLC 11 determines whether or not configuration information is set in the BOX 12A-2′. Here, it is assumed that the type information set in the BOX 12A-2′ matches the type information stored in the SLC 11 and the configuration information is not set in the BOX 12A-2′.

Therefore, the SLC 11 detects that the BOX 12A-2′ installed at the same position as the BOX 12A-2 is the same type as the BOX 12A-2 (S32). Further, the SLC 11 detects that the BOX 12A-2′ has no configuration information (that the configuration information has not been input) (S33).

As described above, in a case where the BOX 12A-2′ is installed at the same position as the BOX 12A-2 and the BOX 12A-2′ is the same type as the BOX 12A-2 and there is no configuration information in the BOX 12A-2′, the SLC 11 determines that the BOX 12A-2′ is installed as an alternative to the BOX 12A-2. In this case, the SLC 11 transmits the configuration information stored in the SLC 11, that is, the configuration information of the BOX 12A-2, to the BOX 12A-2′ (S34).

In a case where the BOX 12A-2′ is installed at a position different from the BOX 12A-2, the BOX 12A-2′ is of a type different from the BOX 12A-2, or in a case where the BOX 12A-2′ has configuration information, the SLC 11 determines that the BOX 12A-2′ is not an alternative to the BOX 12A-2, and does not transmit the configuration information to the BOX 12A-2′.

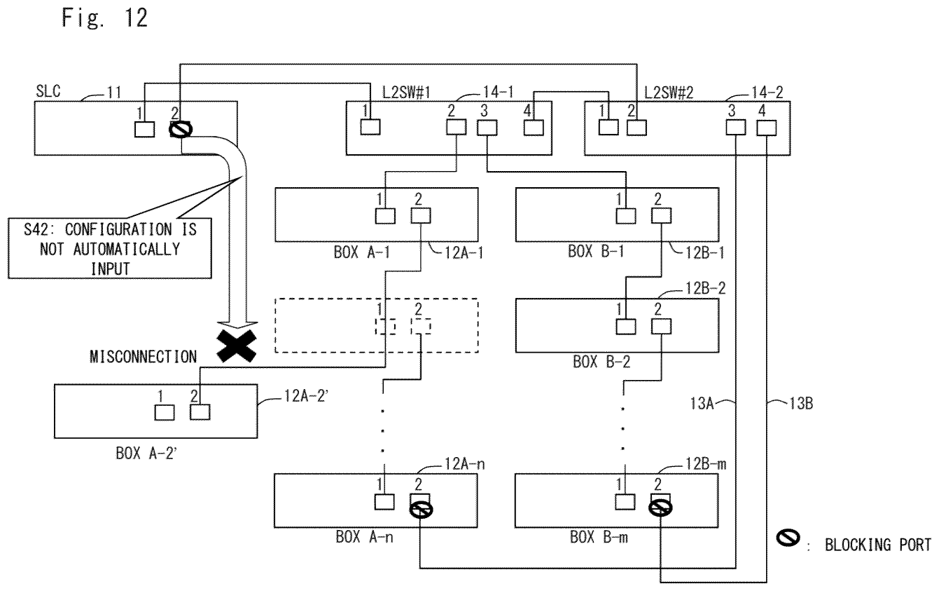

FIG. 12 is a diagram illustrating an operation example in a case where the BOX 12 is installed by misconnection in the network system 2. FIG. 12 illustrates an example in which the BOX 12A-2′ is installed at the same position as the BOX 12A-2 on the transmission path 13A by misconnection.

As illustrated in FIG. 12, the user installs the BOX 12A-2′ at a position where the BOX 12A-2 is installed in the transmission path 13A. Specifically, the user connects only the communication port 121-2 of the BOX 12A-2′ to the transmission path 13A at the position where the BOX 12A-2 was installed. Accordingly, the communication port 121-2 of the BOX 12A-2′ is connected to the communication port 121-2 of the BOX 12A-1.

Here, the SLC 11 updates the network topology information of the transmission paths 13A and 13B by the collection operation of FIG. 6 performed at regular timing after the installation of the BOX 12A-2′.

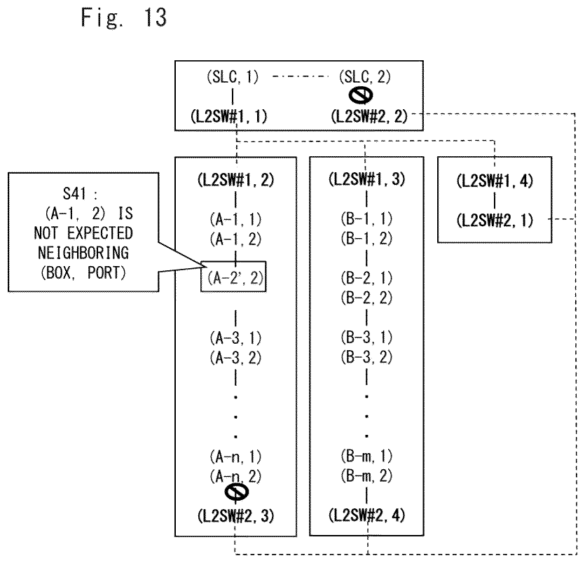

FIG. 13 is a diagram illustrating an example of network topology information of the transmission paths 13A and 13B in the state of FIG. 12.

As illustrated in FIG. 13, the SLC 11 can collect information of the BOX 12A-2′ neighboring the BOXs 12A-1, 12A-3 from the BOXs 12A-1, 12A-3. Therefore, the information of the BOX 12A-2′ neighboring the BOXs 12A-1, 12A-3 is added to the network topology information of the transmission path 13A (S41).

However, according to the network topology information (FIG. 7) of the transmission path 13A during the BOX 12A-2 is installed, the communication port 121-1 of the BOX 12A-2 is connected to the communication port 121-2 of the BOX 12A-1.

On the other hand, according to the current network topology information of the transmission path 13A in which the BOX 12A-2′ is installed, the communication port 121-2 of the BOX 12A-2′ is connected to the communication port 121-2 of the BOX 12A-1.

Therefore, the SLC 11 determines that the BOX 12A-2′ is installed at the same position as the BOX 12A-2 by misconnection, and the BOX 12A-2′ is not an alternative to the BOX 12A-2. Therefore, the SLC 11 does not transmit the configuration information to the BOX 12A-2′ (S42).

As described above, according to the second example embodiment, the electronic apparatus 10X includes two transmission paths 13A and 13B in which the plurality of BOXs 12 are provided in series. The L2SW 14-1 relays the connection between the monitoring port 112-1 and the two transmission paths 13A and 13B. The L2SW 14-2 relays the connection between the monitoring port 112-2 and the two transmission paths 13A and 13B.

Here, from the viewpoint of the STP loop countermeasure, it is not possible to increase the number of BOXs 12 provided in one transmission path 13 infinitely.

On the other hand, according to the second example embodiment, the electronic apparatus 10X includes two transmission paths 13A and 13B in which the plurality of BOXs 12 are provided in series. Therefore, the number of BOXs 12 individually connected to the transmission paths 13A and 13B can be reduced. Further, by increasing the number of transmission paths 13, the number of BOXs 12 connected to the individual transmission paths 13 can be further reduced.

Other effects of the second example embodiment are the same as those of the first example embodiment described above.

### Example Embodiment 3

The third example embodiment corresponds to the example embodiment in which the first example embodiment described above is put into a high-level concept.

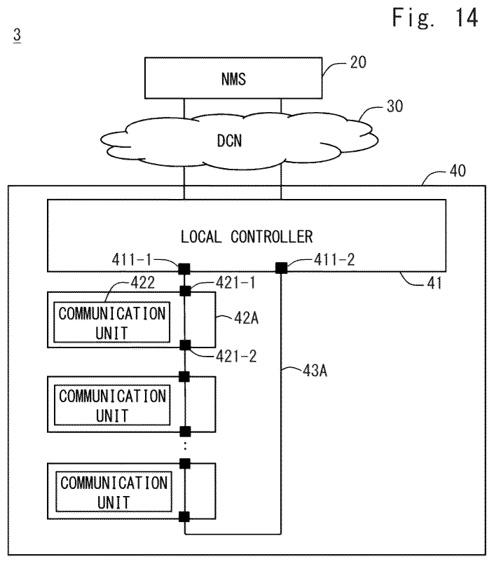

FIG. 14 is a diagram illustrating a configuration example of a network system 3.

As illustrated in FIG. 14, the network system 3 includes an electronic apparatus 40 instead of the electronic apparatus 10 as compared with the network system 1.

The electronic apparatus 40 includes a local controller 41, a plurality of electronic components 42A, and a transmission path 43A.

The local controller 41 monitors each of the plurality of electronic components 42A.

The local controller 41 includes a first monitoring port 411-1 and a second monitoring port 411-2. The first monitoring port 411-1 is connected to the transmission path 43A. The second monitoring port 411-2 is connected to the first monitoring port 411-1 via the transmission path 43A. In the following description, if it is not specified which of the first monitoring port 411-1 and the second monitoring port 411-2 is, it is referred to as a monitoring port 411. The transmission path 43A is a loop-shaped (ring-shaped) transmission path, and a plurality of electronic components 42A are provided in series on the transmission path 43A.

Each of the plurality of electronic components 42A includes a first communication port 421-1, a second communication port 421-2, and a communication unit 422. In the following description, if it is not specified which of the first communication port 421-1 and the second communication port 421-2 is, it is referred to as a communication port 421.

The first communication port 421-1 is connectable to the first monitoring port 411-1 via the transmission path 43A. The second communication port 421-2 is connectable to the second monitoring port 411-2 via the transmission path 43A.

The communication unit 422 communicates with the local controller 41 via the first communication port 421-1 or the second communication port 421-2.

According to the third example embodiment, since the local controller 41 does not need to individually include the monitoring port 411 for performing one-to-one communication with each of the plurality of electronic components 42A in order to monitor each of the plurality of electronic components 42A, the number of the monitoring ports 411 can be reduced.

The first monitoring port 411-1 and the second monitoring port 411-2 included in the local controller 41 are connected to the transmission path 43A. Therefore, the local controller 41 can have a redundant configuration including a component that monitors each electronic component 42A via the first monitoring port 411-1 and a component that monitors each electronic component 42A via the second monitoring port 411-2. Therefore, even if one of these components fails, the monitoring control of each electronic component 42A can be continued.

Thus, according to the third example embodiment, it is possible to secure redundancy in monitoring control of each electronic component 42A while reducing the number of monitoring ports 411 of the local controller 41.

### Example Embodiment 4

The fourth example embodiment corresponds to the example embodiment in which the second example embodiment described above is put into a high-level concept.

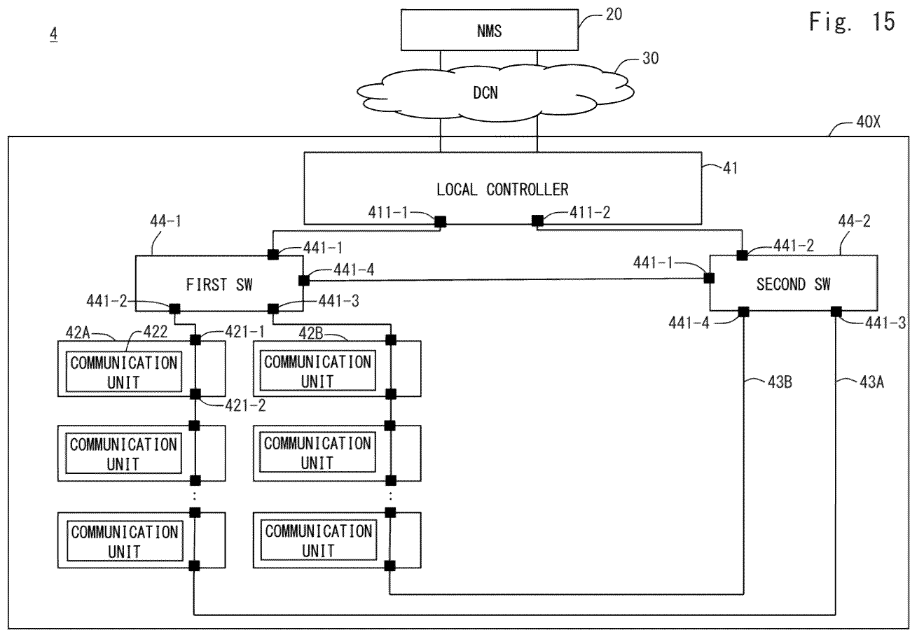

FIG. 15 is a diagram illustrating a configuration example of a network system 4.

As illustrated in FIG. 15, the network system 4 includes an electronic apparatus 40X instead of the electronic apparatus 40 as compared to the network system 3.

The electronic apparatus 40X additionally includes a first switch 44-1 and a second switch 44-2 compared to the electronic apparatus 40.

Further, the electronic apparatus 40X additionally includes a transmission path 43B in which each of the plurality of electronic components 42B is provided in series as compared with the electronic apparatus 40. The electronic component 42B has the same structure as that of the electronic component 42A. In the following description, the electronic components 42A and 42B are referred to as electronic components 42 if they are not specified.

As described above, the electronic apparatus 40X includes two transmission paths 43A and 43B in which the plurality of electronic components 42 are provided in series. In the following description, the transmission path 43A and the transmission path 43B are referred to as the transmission path 43 if it is not specified. However, the electronic apparatus 40X is not limited to being provided with two transmission paths 43A and 43B, and may be provided with three or more transmission paths 43.

The first switch 44-1 relays the connection between the first monitoring port 411-1 and the two transmission paths 43A and 43B. The first switch 44-1 includes relay ports 441-1 to 441-4. In the first switch 44-1, the relay port 441-1 is connected to the first monitoring port 411-1. Further, the relay port 441-2 is connected to the first communication port 421-1 of each electronic component 42 on the transmission path 43A. Further, the relay port 441-3 is connected to the first communication port 421-1 of each electronic component 42 on the transmission path 43B. Further, the relay port 441-4 is connected to a relay port 441-1, which is described later, of the second switch 44-2.

The second switch 44-2 relays the connection between the second monitoring port 411-2 and the two transmission paths 43A and 43B. The second switch 44-2 includes relay ports 441-1 to 441-4. In the second switch 44-2, the relay port 441-2 is connected to the second monitoring port 411-2. Further, the relay port 441-3 is connected to the second communication port 421-2 of each electronic component 42 on the transmission path 43A. Further, the relay port 441-4 is connected to the second communication port 421-2 of each electronic component 42 on the transmission path 43B. The relay port 441-1 is connected to the relay port 441-4 of the first switch 44-1.

According to the fourth example embodiment, it is possible to reduce the number of electronic components 42 individually connected to the transmission paths 43A and 43B. Further, by increasing the number of the transmission paths 43, the number of the electronic components 42 connected to the individual transmission paths 43 can be further reduced.

Other effects of the fourth example embodiment are the same as those of the third example embodiment described above.

Note that the above-described Example embodiments 3 and 4 can be modified as follows.

For example, the local controller 41 may store position information indicating the position of the electronic component 42 on the transmission path 43, type information indicating the type of the electronic component 42, and setting information related to the setting of the electronic component 42 in association with each of the plurality of electronic components 42.

Further, in a case where detecting that the first electronic component 42 of the plurality of electronic components 42 has been removed from the transmission path 43, the local controller 41 may specify the first position information, the first type information, and the first setting information associated with the first electronic component 42. Further, in a case where the local controller 41 detects that the second electronic component 42 having the first type information is attached to the position corresponding to the first position information and detects that the second electronic component 42 does not have the information corresponding to the setting information, the local controller 41 may determine that the second electronic component 42 is an alternative to the first electronic component 42.

In a case where the local controller 41 determines that the second electronic component 42 is an alternative to the first electronic component 42, the local controller 41 may transmit the first setting information to the second electronic component 42.

Further, the position information may include information indicating the position of the electronic component 42 on the transmission path 43 and information indicating the first communication port 421-1 or the second communication port 421-2 connected to the transmission path 43 at the position. Further, in a case where the local controller 41 detects that the communication port 421 different from the communication port 421 corresponding to the first position information is connected to the transmission path 43 with respect to the second electronic component 42 attached to the position corresponding to the first position information, the local controller 41 may determine that the second electronic component 42 is not an alternative to the first electronic component 42.

In addition, in a case where the local controller 41 detects that the third electronic component 42 is attached to an arbitrary position on the transmission path 43 and detects that another electronic component 42 is not removed before the third electronic component 42 is attached at the position, the local controller 41 may determine that the third electronic component 42 is not an alternative.

Further, each of the plurality of electronic components 42 may acquire neighboring information indicating the neighboring electronic component 42 by using LLDP. Further, the local controller 41 may collect neighboring information from each of the plurality of electronic components 42 using LLDP, generate position information, based on the collected neighboring information, and store the generated position information.

In addition, the communication unit 422 may determine which of the first communication port 421-1 and the second communication port 421-2 is to be used according to the position of the blocking point provided on the transmission path 43, and may communicate with the local controller 41 via the determined communication port 421.

<Hardware Configuration of Electronic Apparatus According to Example embodiment>

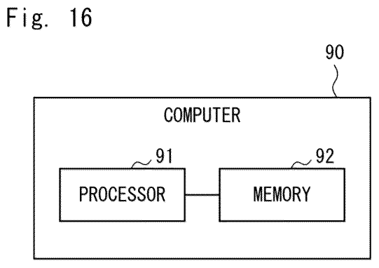

FIG. 16 is a block diagram illustrating a hardware configuration example of a computer 90 that implements the electronic apparatuses 10, 10X, 40, and 40X described above.

As illustrated in FIG. 16, the computer 90 includes a processor 91 and a memory 92. The processor 91 and the memory 92 are coupled to each other.

The processor 91 may be, for example, a microprocessor, a micro processing unit (MPU), or a central processing unit (CPU). The processor 91 may include a plurality of processors.

The memory 92 includes a combination of a volatile memory and a non-volatile memory. The memory 92 may include storage located remotely from the processor 91. In this case, the processor 91 may access the memory 92 via an input/output interface (I/O) (not illustrated).

The memory 92 may store a software module (computer program) including instructions and data for performing processing by the electronic apparatuses 10, 10X, 40, and 40X described above.

In some implementations, the processor 91 may be configured to read and execute the software module from the memory 92 to perform the processing of the electronic apparatuses 10, 10X, 40, and 40X described above.

Further, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

While the present disclosure has been particularly illustrated and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Further, each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### (Supplementary Note 1)

An electronic apparatus including:
a plurality of electronic components;
a transmission path configured to be provided with a plurality of the electronic components in series; and
a local controller configured to monitor a plurality of the electronic components, in which
the local controller includes a first monitoring port connected to the transmission path, and
a second monitoring port connected to the first monitoring port via the transmission path, and
each of a plurality of the electronic components includes a first communication port connectable to the first monitoring port,
a second communication port connectable to the second monitoring port, and
a transceiver communicating with the local controller via the first communication port or the second communication port.

### (Supplementary Note 2)

The electronic apparatus according to Supplementary Note 1, including
a first switch configured to be connected to the first monitoring port and a second switch configured to be connected to the second monitoring port, and
a plurality of the transmission paths in which a plurality of the electronic components are provided in series, in which
the first switch relays a connection between the first monitoring port and a plurality of the transmission paths, and
the second switch relays a connection between the second monitoring port and a plurality of the transmission paths.

### (Supplementary Note 3)

The electronic apparatus according to Supplementary Note 1 or 2, in which the local controller stores position information indicating a position of the electronic component on the transmission path, type information indicating a type of the electronic component, and setting information related to a setting of the electronic component in association with each of a plurality of the electronic components.

### (Supplementary Note 4)

The electronic apparatus according to Supplementary Note 3, in which, in a case where the local controller detects that a first electronic component of a plurality of the electronic components is removed from the transmission path, the local controller identifies first position information, first type information, and first setting information being associated with the first electronic component, and in a case where the local controller detects that a second electronic component having the first type information is attached to a position associated with the first position information and detects that the second electronic component does not have information associated with the setting information, the local controller determines that the second electronic component is an alternative to the first electronic component.

### (Supplementary Note 5)

The electronic apparatus according to Supplementary Note 4, in which, in a case where the local controller determines that the second electronic component is an alternative to the first electronic component, the local controller transmits the first setting information to the second electronic component.

### (Supplementary Note 6)

The electronic apparatus according to Supplementary Note 4, in which
the position information includes information indicating a position of the electronic component on the transmission path and information indicating the first communication port or the second communication port being connected to the transmission path at the position, and,
in a case where the local controller detects that a communication port different from a communication port associated with the first position information is connected to the transmission path with respect to the second electronic component attached to a position associated with the first position information, the local controller determines that the second electronic component is not an alternative to the first electronic component.

### (Supplementary Note 7)

The electronic apparatus according to Supplementary Note 3, in which, in a case where the local controller detects that a third electronic component is attached to any position on the transmission path and that another electronic component is not removed before the third electronic component is attached at the position, the local controller determines that the third electronic component is not an alternative.

### (Supplementary Note 8)

The electronic apparatus according to Supplementary Note 3, in which
each of a plurality of the electronic components uses a link layer discovery protocol (LLDP) and acquires neighboring information indicating the neighboring electronic component, and
the local controller uses the LLDP and collects the neighboring information from each of a plurality of the electronic components, generates the position information, based on the collected neighboring information and stores the generated position information.

### (Supplementary Note 9)

The electronic apparatus according to Supplementary Note 1, in which the transceiver determines which of the first communication port and the second communication port is to be used according to a position of a blocking point provided on the transmission path, and communicates with the local controller via the determined communication port.

### (Supplementary Note 10)

A network system including:
the electronic apparatus according to Supplementary Note 1; and
a network management system (NMS) configured to monitor the electronic apparatus.

Note that, some or all of elements (e.g., structures and functions) specified in Supplementary Notes 2 to 9 dependent on Supplementary Note 1 may also be dependent on Supplementary Note 10 in dependency similar to that of Supplementary Notes 2 to 9 dependent on Supplementary Note 1. Some or all of elements specified in any of Supplementary Notes may be applied to various types of hardware, software, and recording means for recording software, systems, and methods.

What is claimed is:

1. An electronic apparatus comprising:
a plurality of electronic components;
a transmission path configured to be provided with a plurality of the electronic components in series; and
a local controller configured to monitor a plurality of the electronic components, wherein
the local controller includes a first monitoring port connected to the transmission path, and
a second monitoring port connected to the first monitoring port via the transmission path, and
each of a plurality of the electronic components includes a first communication port connectable to the first monitoring port,
a second communication port connectable to the second monitoring port, and
a transceiver communicating with the local controller via the first communication port or the second communication port.

2. The electronic apparatus according to claim 1, further comprising
a first switch configured to be connected to the first monitoring port and a second switch configured to be connected to the second monitoring port, and
a plurality of the transmission paths in which a plurality of the electronic components are provided in series, wherein
the first switch relays a connection between the first monitoring port and a plurality of the transmission paths, and
the second switch relays a connection between the second monitoring port and a plurality of the transmission paths.

3. The electronic apparatus according to claim 1, wherein the local controller stores position information indicating a position of the electronic component on the transmission path, type information indicating a type of the electronic component, and setting information related to a setting of the electronic component in association with each of a plurality of the electronic components.

4. The electronic apparatus according to claim 3, wherein, in a case where the local controller detects that a first electronic component of a plurality of the electronic components is removed from the transmission path, the local controller identifies first position information, first type information, and first setting information being associated with the first electronic component, and,
in a case where the local controller detects that a second electronic component having the first type information is attached to a position associated with the first position information and detects that the second electronic component does not have information associated with the setting information, the local controller determines that the second electronic component is an alternative to the first electronic component.

5. The electronic apparatus according to claim 4, wherein, in a case where the local controller determines that the second electronic component is an alternative to the first electronic component, the local controller transmits the first setting information to the second electronic component.

6. The electronic apparatus according to claim 4, wherein
the position information includes information indicating a position of the electronic component on the transmission path and information indicating the first communication port or the second communication port being connected to the transmission path at the position, and,
in a case where the local controller detects that a communication port different from a communication port associated with the first position information is connected to the transmission path with respect to the second electronic component attached to a position associated with the first position information, the local controller determines that the second electronic component is not an alternative to the first electronic component.

7. The electronic apparatus according to claim 3, wherein, in a case where the local controller detects that a third electronic component is attached to any position on the transmission path and that another electronic component is not removed before the third electronic component is attached at the position, the local controller determines that the third electronic component is not an alternative.

8. The electronic apparatus according to claim 3, wherein
each of a plurality of the electronic components uses a link layer discovery protocol (LLDP) and acquires neighboring information indicating the neighboring electronic component, and
the local controller uses the LLDP and collects the neighboring information from each of a plurality of the electronic components, generates the position information, based on the collected neighboring information, and stores the generated position information.

9. The electronic apparatus according to claim 1, wherein the transceiver determines which of the first communication port and the second communication port is to be used according to a position of a blocking point provided on the transmission path, and communicates with the local controller via the determined communication port.

10. A networked system comprising:
the electronic apparatus according to claim 1; and
a network management system (NMS) configured to monitor the electronic apparatus.
